(19) United States
(12) Patent Application Publication
(10) Pub. No.: US 2011/0100731 A1
(43) Pub. Date: May 5, 2011

(54) PERPETUAL FUEL-FREE ELECTRIC VEHICLE

(76) Inventor: M. Hassan Hassan, Windermere, FL (US)

(21) Appl. No.: 12/610,095

(22) Filed: Oct. 30, 2009

(51) Int. Cl. B60L 8/00

(52) U.S. Cl. 180/2.2

(57) ABSTRACT

The invention is a method used to generate an adequate electrical power to charge a plurality of storage batteries driving a perpetual, fuel-free electric vehicle or alike. The batteries supply adequate power to at least one electric motor to propel the vehicle and supply electricity to all other vehicle instruments such as lights, wipers, defogger, etc. Two alternative, green energy sources are used to continuously charge the batteries: solar energy generated from solar panels covering every and all possible areas of the vehicle's exterior surface and wind energy generated by one or more electric generators driven by one or more wind turbines mounted within the vehicle and placed under its exterior surface. All or most front, top and side wind streams, surrounding the vehicle, are channeled through air passages. Each air passage is designed as a funnel-like air duct where the end of the air duct with the smaller cross-sectional area is directed into the entry of the wind turbine system to accelerate the streamlined winds. The energy of the aggregated and accelerated winds is harnessed by one or more wind turbine systems placed in the path of the wind streams. Each wind turbine system has an electric generator to convert the rotational energy of the turbine's shaft into electric energy. The output of each wind turbine generator is applied to a controller unit where electric voltage is regulated and converted, if necessary, to charge the plurality of storage batteries. The outputs of the solar panels are also applied to the controller unit to be regulated and converted if necessary to charge the plurality of storage batteries. The controller unit continuously charges the batteries of the electric vehicle whether the vehicle is stopped or running. The controller unit is also connected to an external, stand-by power supply unit used only to charge the batteries under unexpected circumstances such as system failure.

### CROSS REFERENCE TO RELATED APPLICATION

M. H. Hassan, “Solar and Wind-Powered Vehicle (Fuel-Less Vehicle), US Patent and Trademark Office, Disclosure Document NO. 598626, Dated Apr. 13, 2006.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates generally to electric vehicles operated by electric motors relying on a set of batteries as a stored energy source, specifically to such vehicles, in which the batteries are recharged and electric motors are powered by solar and wind sustainable energy sources.

2. Description of the Prior Art

Due to the continuous depletion of world supply of fossil fuel and the continuous increase in both fuel cost and pollution to the environment, alternative green sources of energy have been investigated for possible use in powering vehicles, such as automobiles, trucks, buses, trains, airplanes, etc. Alternative sources of energy have also been investigated as means to reduce pollution levels in cities and towns throughout the world; a major portion of such pollution is generated by fossil fuel such as gas, diesel, etc. used in today's vehicles. Such investigations are focused on electrically powered vehicles driven by at least one electric motor due to the non-polluting nature inherent with electrical motors and in view of the ready supply of electricity to run the electric motors.

A permanent connection of the electric motor to electrical power supply lines is impossible due to the mobility of the vehicles, that is, vehicles are not fixed at one location. Therefore, in an electrically powered vehicle, a set of batteries are mounted within the vehicle used as storage to supply electricity needed to run the electric motor(s) and all other functions in the vehicle.

In previously constructed electric vehicles, batteries are typically heavy and are required in large numbers to provide an adequate driving range between recharging periods. Batteries are recharged at home, office, recharging stations, etc. by suitable power supply units. Therefore, such batteries still utilize electricity generated by conventional means such as fossil fuel, coal, hydro, nuclear, etc. with dire consequences to the environment.

Other designs used wind turbines to generate electricity to charge the batteries where these turbines are placed on the top of the vehicle. Such action ignores most of the useful wind streams surrounding the vehicle, especially the very important right side and left side wind streams, and increases drag forces on the vehicle, hence, reducing the effective electric power generated from the wind turbine's generator. Additionally the designs are not practical or even not safe for domestic use. Other types of electric vehicles use solar panels to generate electricity to recharge the batteries and often-such designs are not successful for regular vehicles with many passengers driving on a typical highway due to the limited area and the low efficiency of the solar panels, hence, the limited electric power they generate. Most, if not all, of the previously proposed electric vehicles have limitations in driving range, driving speed, number of passengers, and/or safety. In addition, some electric vehicles depend directly or indirectly on fossil fuel, coal, hydro, nuclear, etc. with dire consequences on the environment.

Examples of prior art electric vehicles are found in several U.S. patents. In Dykes U.S. Pat. No. 3,575,250 (1971) a two-wheeled vehicle with a quick-disconnect battery hung between the two wheels is connected to a variety of wheeled devices, such as a supermarket cart, to provide an articulated assembly driven by the two-wheeled vehicle. Each wheel of the two-wheeled vehicle has its own motor. The motors are series-connected at one setting and parallel connected at another, and “in turning, one of the motors will load and slow down and the other will speed up in a differential action to assist in the turning of the vehicle.”

In Adams U.S. Pat. No. 3,934,669 (1976) a two wheeled, electric vehicle having an outer contour resembling a piece of luggage is proposed. An electrically powered motor mounted to the steering column provides the motive force for driving the steered wheel to propel the vehicle.

In Dow U.S. Pat. No. 3,190,387 (1965) a four-wheeled vehicle has two drive wheels each provided with its own motor carried on the vehicle frame, which is sprung on the wheels. The batteries are carried over the rear axle of the vehicle but forwardly of the motors and on the sprung frame.

In Hafer U.S. Pat. No. 3,708,028 (1973) an electric truck is provided with a battery pack that can be positioned and removed from the side of the truck with a forklift truck.

In Ward U.S. Pat. No. 4,042,055 (1977) an electric vehicle can carry “two 180-pound riders and two 20 or 30-pound golf bags more than 40 holes on a moderately hilly golf course using four standard 62.5 pound 6-volt rechargeable batteries.”

In Maki et al. U.S. Pat. No. 3,960,090 (1976) an electric vehicle powered by a linear synchronous motor is proposed. “The linear synchronous motor comprises a series of field poles fitted on the vehicle body along its total length and a series of magnetic devices being provided along a track on the ground facing these field poles and developing a traveling magnetic field. A driving force developed between these field poles and the magnetic devices causes the vehicle to move.” The magnetic devices on the truck are energized by external electrical current sources.

In Boudreaux U.S. Pat. No. 7,605,493 B1 (2009) proposes an electrical vehicle powered by a generator and the generator driven by gasoline. This, in turn, will cause the same dire impacts on the environment produced by a regular fossil fuel vehicle or alike.

In Richardson U.S. Pat. No. D374,656 (1996) an ornamental design for a car top wind generator is presented. This design is not only dangerous but deemed useless due to the huge drag forces it generates. Similarly in Trumpy U.S. Pat. No. 4,282,944 (1981) a wind motor generator with three vanes mounted on the top of the vehicle is also presented. In Amick U.S. Pat. No. 4,117,900 (1978) a passenger car deriving all or a part of its motive power from the wind through a system of one or more rigid vertical airfoils is presented. In Bussiere U.S. Pat. No. 4,423,368 (1983) a turbine air battery charger is presented. Bussiere collects only a portion of the top wind steam ignoring all front and side winds surround the vehicle. He divides one air stream into two outlets driving two wind turbines rather than combing the two outlets mechanically to drive only one turbine. As in Bussiere, Brierley U.K. Pat. No. GB2126963A (1982) proposed an air-powered electrical vehicle yet ignoring all side wind streams surrounding the vehicle.

In Kim U.S. Pat. No. 7,445,064 B2 (2008) a vehicle using wind force is presented and a wind ventilator is placed externally on the top of the trunk. This design harnesses a small portion of the wind forces and ignores all right side and left side winds surrounding the vehicle. Kim uses maglev forces to rotate the generator shaft when the “winds does not blow” and to keep the generator operating and the batteries continuously charging. Kim, however, fails to tell us how he is going to supply the required alternating electric current to the coils in the disk wall to change the polarity of the magnetized coils and generate the disk rotational movement. If Kim uses the same batteries that he wants to charge as the source of the alternating current, the design is deemed a failure. Nevertheless, Kim states, “electric power charged through the solar heat charging plate 13 is stored in the charger 14 helps the rotary gear 32 to rotate, while driving the small-sized motor 40.” Kim does not clarify how he stores “electric power” in a “charger” to run a small motor or two small motors. Kim also does not explain how he converts “solar heat” to electricity. Additionally, depending on a “solar heat charging plate” to run a generator may be less than reliable.

A solar powered vehicle utilizing solar panels to charge storage batteries for energizing the electric motor of an electric vehicle is proposed by Tomei U.S. Pat. No. 4,592,436 (1986). Due to the limited area of the solar panels used on the vehicle and their low efficiency, electric vehicles powered exclusively by solar panels may have many limitations, especially in speed, efficiency, weight, and number of passengers.

Other known prior art devices include U.S. Pat. No. 3,477,537, U.S. Pat. No. 3,659,672, U.S. Pat. No. 3,713,504, U.S. Pat. No. 3,870,935, U.S. Pat. No. 4,113,045, U.S. Pat. No. 4,196,785, U.S. Pat. No. 4,444,285, U.S. Pat. No. 5,172,784, U.S. Pat. No. 5,212,431, U.S. Pat. No. 5,323,868, U.S. Pat. No. 5,461,289, U.S. Pat. No. 5,515,937, U.S. Pat. No. 5,566,774, U.S. Pat. No. 5,586,613, U.S. Pat. No. 5,705,859, U.S. Pat. No. 5,713,426, U.S. Pat. No. 5,722,502, U.S. Pat. No. 5,786,640, U.S. Pat. No. 5,842,534, U.S. Pat. No. 5,847,470, U.S. Pat. No. 5,848,659, U.S. Pat. No. 5,875,864, U.S. Pat. No. 5,887,674, U.S. Pat. No. 5,927,416, U.S. Pat. No. 5,939,794, U.S. Pat. No. 5,978,719, U.S. Pat. No. 6,059,059, U.S. Pat. No. 6,213,234 B1, U.S. Pat. No. 6,294,843 B1, U.S. Pat. No. 7,565,937 B2, U.S. Pat. No. 7,520,352 B2, U.S. Pat. No. 7,530,920 B2, U.S. Pat. No. 7,478,692 B2, U.S. Pat. No. 7,497,285 B1, and U.S. Pat. No. 7,453,231 B2.

While these devices fulfill their respective, particular objectives and requirements, the aforementioned patents do not disclose a new perpetual, solar and wind powered electric vehicle where all or most wind forces are harnessed and all or most solar energy is collected. The inventive device include an energy efficient electric vehicle having one or more wind turbines driven by all or most winds surrounding the vehicle directed through funnel-shaped air passages or ducts where the smaller cross-sectional area pointed into the entry of the wind turbine system to accelerate the collected winds. All wind turbines are enclosed within the vehicle structure and below its chassis; hence, wind turbines do not generate any drag forces on the vehicle or cause any danger or obstacle to the public and users. Solar energy is also continuously collected and used along with the wind energy to charge the batteries of the vehicle at all times.

In these respects, the Electric Vehicle according to the present invention substantially departs from the conventional concepts and designs of the prior art, and in so doing, provides an apparatus and method primarily developed for the purpose of constructing a perpetual, fuel-free electric vehicle capable of being used by one or many passengers at normal speeds in cities and towns, and on highways and byways, and in rain or shine.

### SUMMARY OF THE INVENTION

In view of the foregoing disadvantages inherent in the known types of Fuel-Free Electric Vehicles now present in the prior art, the present invention provides a new Solar and Wind Powered, Perpetual, Fuel-Free Electric Vehicle; wherein the same can be utilized for providing a reliable electric vehicle capable of being used by one or many passengers at normal speeds in cities and towns, and on highways and byways, and in rain or shine.

There is disclosed herein a unique solar and wind powered electric vehicle utilizing electrical power converted from both incident solar radiation and wind stream surrounding the vehicle. The solar radiation is converted by solar panels comprising a series of photovoltaic (PV) cells, which are arranged in a thin layer on every and all-available surface of the vehicle exterior to capture the maximum amount of solar radiation. As commonly known, PV cells are made of semiconductor materials such as silicon and alloys of indium, gallium and nitrogen. As the interconnection of the individual cells is well known and is not germane to the present invention, details of such interconnection will not be described herein. It will be understood, however, that such individual PV cells are interconnected so as to provide through a common output cable a constant flow of electric energy. Such electrical energy is applied by a solar charger unit 42 to a controller unit 50 to charge the battery array 48 of the electric vehicle 10.

The wind streams surrounding the vehicle at the front of the vehicle, the top of the vehicle, the left side and the right side of the vehicle are harnessed by air inlets and passed through by a funnel-like air ducts into one or more wind turbines. To collect the maximum amount of wind streams and to accelerate the collected winds, each funnel-like air duct has the largest cross-section area at the vehicle surface to collect the maximum amount of the prospective wind stream and the smallest cross section area of the air duct is directed to the wind turbine system. The higher the level of streamlined wind achieved and the smaller the cross-sectional area of the air duct at the entry of the wind turbine system, the greater the streamlined wind and the higher will be its velocity on entry into the wind turbine system; hence, the maximum generated electricity. Each wind turbine system comprises: (1) rotor blades to capture wind energy; (2) a shaft to transfer rotational energy to an electric generator and (3) nacelle casing that holds (a) a gearbox to increase speed of shaft between rotor hub and electric generator; (b) an electric generator to convert rotational energy into electricity; (c) an electronic controller to monitor system, move rotor to align with direction of winds as known as yaw mechanism control, and shut system in case of malfunction; and (d) brakes to stop shaft rotation in case of overload and or system failure. As wind turbine system is well known and is not germane to the present invention, details of such system will not be described herein. It will be understood, however, that such individual wind turbine system is installed so as to provide through a common output cable a constant flow of electric energy. Such electrical energy is applied by a wind regulator unit 44 to a controller unit 50 to charge the battery array 48 of the electric vehicle 10.

### BRIEF DESCRIPTIONS OF THE DRAWINGS

The invention will be better understood and objects other than set forth above will become apparent when consideration is given to the following detailed description thereof. Such description makes reference to the annexed drawings wherein:

FIG. 1 is a perspective view of a solar and wind powered electric vehicle according to the present invention.

FIG. 2 is a schematic view of the funnel-like air ducts in the electric vehicle of FIG. 1.

FIG. 3 is perspective view of an alternative embodiment of the invention, showing two wind turbine systems.

FIG. 4 is a schematic view of the funnel-like air ducts in the electric vehicle of FIG. 3.

FIG. 5 is a schematic block diagram of the electrical system utilized in the solar and wind powered electric vehicle of this invention.

Drawings Reference Numerals

| | |
|---|---|
| 10 electric vehicle | 12 solar panels |
| 14 wind turbine system | 16 front wind inlet |
| 18 top wind inlet | 20 right-side wind inlet |
| 21 left-side wind inlet | 22 front wind stream |
| 24 top wind stream | 26 side wind stream |
| 28 air duct | 30 front wind turbine system |
| 32 rear wind turbine system | 34 electric motor |
| 36 accelerator pedal | 38 potentiometer |
| 40 12 V accessory battery | 42 solar charger |
| 44 wind charger | 46 emergency power supply |
| 48 battery array | 50 controller |
| 52 transmission | 54 other vehicle functions |

### DESCRIPTIONS OF THE PREFERRED EMBODIMENTS

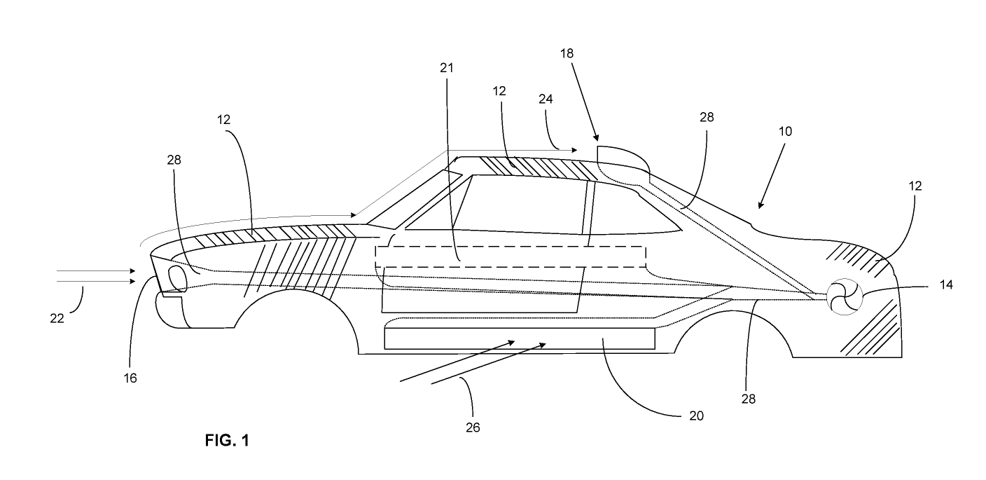

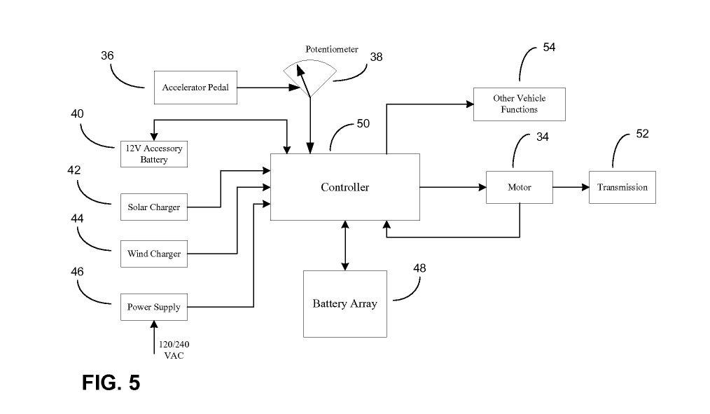

Throughout the following description and drawing, an identical reference numeral is used to refer to the same component shown in multiple figures of the drawings. With reference now to the drawings, and in particular to FIG. 1 through FIG. 5 thereof, a new Perpetual, Fuel-Free Electric Vehicle embodying the principles and concepts of the present invention and generally designated by the reference numeral 10 will be described.

Referring to FIG. 1 through FIG. 5, there is illustrated a solar and wind powered vehicle 10 constructed in accordance with principles and concepts of the present invention. The solar and wind powered vehicle 10 is a conventional electrically powered vehicle having at least one electric motor 34 mounted therein which is connected to the vehicle transmission and driving train for propelling the vehicle. The electric motor 34 receives electrical power from the controller unit 50 and the controller unit 50 gets its power from an array of rechargeable batteries 48. The controller unit 50 controls the electric motor's speed using a closed-loop feedback control system. The driver presses an accelerator pedal 36 to control the speed of the vehicle 10; the voltage signal from the potentiometer 38 changes accordingly. The voltage signal from the potentiometer 38 tells the controller how much power to deliver to the electric car's motor.

Further, there would be provided a 12-volt accessory battery 40 for powering the normal electrical components and other vehicle functions, namely the lights, radio, horn, fan, heater, defogger and other units. The provided 12-volt accessory battery 40 is continuously charged from the battery array 48 by a DC-DC voltage converter/charger, not shown, built within the controller unit 50.

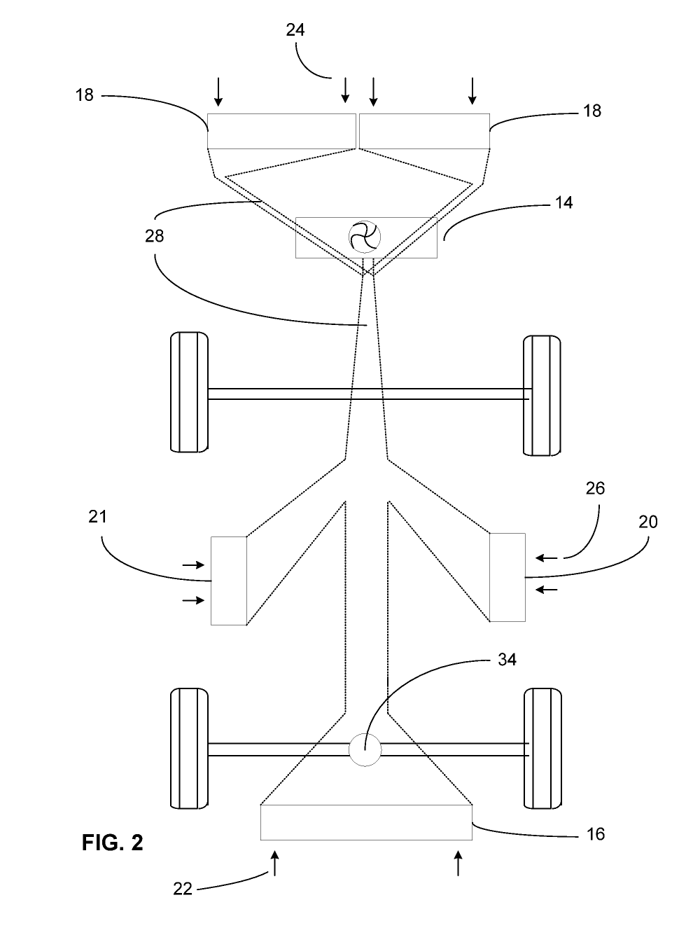

With reference now to FIG. 1, the basic embodiment of the present invention, the vehicle 10 is provided with a plurality of solar panels 12 and a wind turbine system 14 to harness both solar, wind energies and convert them to electrical energy. The solar panels 12 are electrically connected to a solar charger 42 which is electrically connected to the controller unit 50 which supply electrical current thereto for recharging the battery array 48. Referring to FIG. 1 and FIG. 2, the vehicle 10 is provided with front wind inlet 16, top wind inlet 18, right-side wind inlet 20, and left-side wind inlet 21. Each wind inlet is connected to a funnel-like air duct 28 where the largest cross-section area of the air duct 28 at the vehicle surface to collect the maximum amount of the prospective wind stream and the smallest cross section area of the air duct 28 is at the entry of the wind turbine system 14. As shown in FIG. 2, the air ducts 28 of the top wind inlet 18 extend along two sides of the fender wall then connect mechanically with all other air ducts 28 at a point before the wind turbine system 14 and the streamlined winds from all air ducts are applied collectively to the blades of the wind turbine system 14. The generated electrical energy by the wind turbine system generator, not shown, is applied to the wind charger 44 which is electrically connected to the controller unit 50 which supply electrical current thereto for recharging the battery array 48.

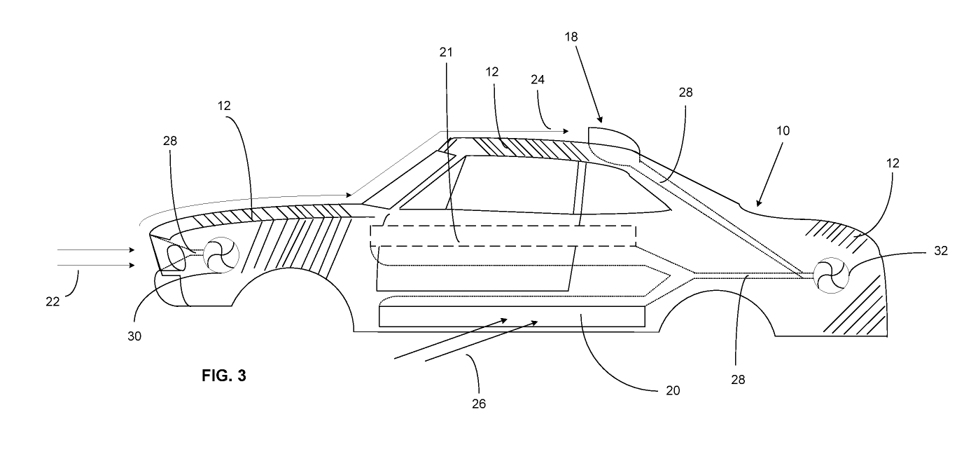

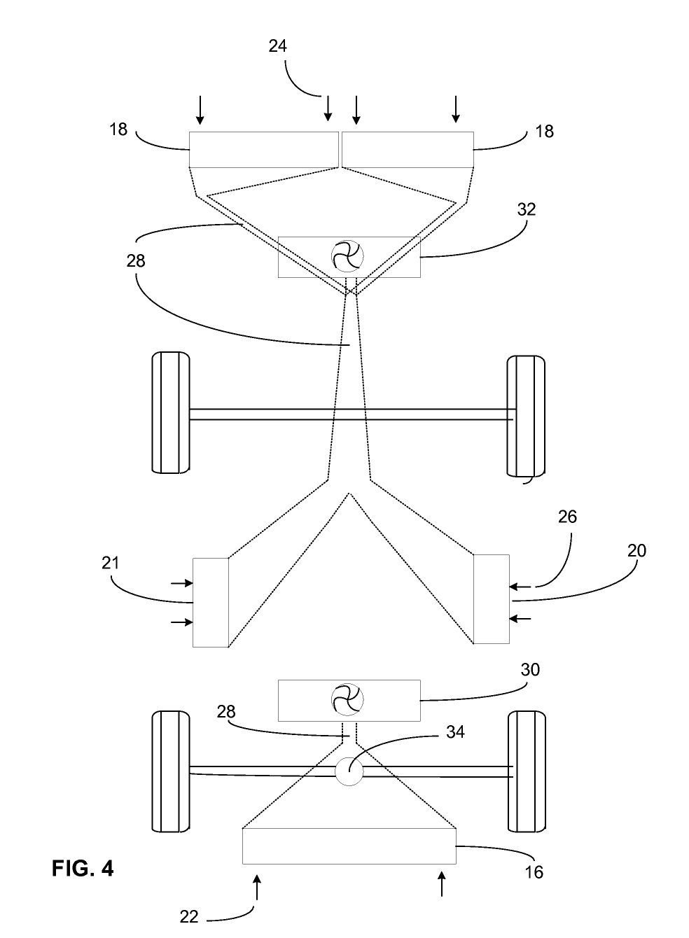

FIG. 3 and FIG. 4 show an alternative embodiment of the invention, in which solar panels 12 and two wind turbine systems are provided. Front wind turbine system 30 and rear wind turbine system 32 are provided to generate more electrical energy than the basic embodiment shown in FIG. 1. The front winds passing through the front wind inlet 16 drives the front wind turbine system 30. The streamed winds from the side wind inlets 20 and 21 and the top wind inlet 18 combined together to drive the rear wind turbine system 32. The electrical outputs of the generators of both the front wind turbine system 30 and the rear wind turbine system 32 are applied to the wind charger 44 which is electrically connected to the controller unit 50 which supply electrical current thereto for recharging the battery array 48. Other alternative embodiments of the invention, in which three or more wind turbine systems at different locations and two or more electric motors can be easily presented.

In case of system failure or unexpected emergency, the storage battery array 48 may be recharged by a conventional power supply unit 46 through a connection to a suitable source of electrical energy, such as an electrical outlet within a building or residential home.

As to a further discussion of the manner of usage and operation of the present invention, the same should be apparent from the above description. Accordingly, no further discussion relating to the manner of usage and operation will be provided.

While there have been described above the principles of this invention in connection with specific apparatus, it is to be clearly understood that this description is made only by way of example and not as a limitation to the scope of the invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Thus the scope of the invention should be determined by the appended claims and their legal equivalents, rather than by the examples given.

I claim:

1. A solar and wind powered electric vehicle comprising: at least one electric motor for propelling the vehicle; a plurality of electric storage batteries mounted within the vehicle for providing electrical power to the electric motor; a plurality of solar panels mounted on the exterior of the vehicle and electrically connected to the array of electric storage batteries for converting incident solar radiation into electricity for charging the batteries; and at least one wind turbine system mounted within the vehicle and electrically connected to the array of electric storage batteries for converting wind energy to electricity for charging the batteries.

2. The electric vehicle of claim 1 wherein the solar panels are mounted on every available surface of the exterior surface of the vehicle to harness the maximum solar energy; said solar panels comprising a series of photovoltaic, solar cells to convert solar radiation incident thereon into electricity through a common output cable which is electrically connected to a solar charger 42 that is electrically connected to a controller 50 to charge a plurality of electric storage batteries 48.

3. The electric vehicle of claim 1 wherein the wind turbine system driven by streamlined winds collected from the front, top, right side, and left side of the vehicle through a plurality of inlets and funnel-like air ducts; such air ducts are mechanically connected at a point before the entry into the wind turbine system where the cross-section areas of the air ducts are the smallest and directed therein to the blades of the wind turbine system.

4. The wind turbine system of claim 3 comprising rotor blades; a shaft, and nacelle casing that holds a gearbox, an electric generator to convert rotational energy into electricity; an electronic controller, and brakes; said wind turbine system is installed so as to provide through a common output cable which is electrically connected to a wind regulator unit 44 that is electrically connected to a controller unit 50 to charge a plurality of electric storage batteries 48. All wind turbine systems and plurality of air ducts are mounted within the vehicle and under its exterior surface.
